(19) United States
(12) Patent Application Publication
(10) Pub. No.: US 2026/0054778 A1
(43) Pub. Date: Feb. 26, 2026

(54) UNIVERSAL BRACKET AND MOUNTING SYSTEM

(71) Applicant: Cruiser Accessories, LLC, Monument, CO (US)

(72) Inventors: Todd R. Spencer, Monument, CO (US); Mark Hunter Basenberg, JR., Colorado Springs, CO (US); Eldon L. Goates, Colorado Springs, CO (US)

(21) Appl. No.: 18/814,394

(22) Filed: Aug. 23, 2024

(51) Int. Cl. B62D 25/16; F16B 2/06

(52) U.S. Cl. CPC B62D 25/166; F16B 2/06

(57) ABSTRACT

Universal brackets comprising universal yokes that are compatible with a variety of yoke caps are disclosed. Selection of a particular yoke cap determines the size of an opening formed when the yoke and yoke cap are joined to form the bracket, which can be used, for example, in mudflap mounting systems that optionally include additional safety features, such as cylindrical clamps, bent support arms, flared rods, and reinforced mudflaps.

### BACKGROUND

The use of brackets in mechanical systems is ubiquitous where it is necessary to physically connect one object to another. However, in practice, use of a correctly sized bracket does not always occur because it is expensive for retailers and consumers to buy and stock brackets in a wide variety of sizes. Unfortunately, size mismatch leads to several dangerous conditions, including loosening of components over time, structural deformation, mechanical fatigue, and total failure, all of which are expedited by vibration, friction, and/or extreme temperature swings. Given these expediting factors, it is especially important for automotive systems to utilize properly sized brackets.

Also, in automotive systems, vibration, friction, and extreme temperature swings contribute to loosening between clamps and clamped objects with the potential for complete separation that could result in road-surface debris, accidents, and costly repairs.

Given these serious considerations, mudflap mounting systems, which incorporate both brackets and clamps within an automotive system, require a high level of design and engineering. Further, mudflaps themselves are often connected to mounting systems by relatively few fasteners expected to handle the weight of the mudflap at a handful of highly localized positions. This configuration frequently results in tearing and/or elongation of mudflap holes that receive the fasteners.

Devices and methods for improving mechanical connections, increasing safety, and overcoming many of the challenges mentioned above are disclosed hereinafter.

### SUMMARY

This Summary is provided to introduce in a simplified form a selection of concepts that are further described below in the Detailed Description. This Summary is not intended to identify key or essential features of the claimed subject matter, nor is it intended to be used to limit the scope of the claimed subject matter.

As used herein, “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B, and C together. When each one of A, B, and C in the above expressions refers to an element, such as X, Y, and Z, or class of elements, such as X1-Xm, Y1-Yn, and Z1-Zo, the phrase is intended to refer to a single element selected from X, Y, and Z, a combination of elements selected from the same class (e.g., X1 and X2) as well as a combination of elements selected from two or more classes (e.g., Y1 and Z3).

It is to be noted that the term “a entity” or “an entity” refers to one or more of that entity. As such, the terms “a” (or “an”), “one or more,” and “at least one” can be used interchangeably herein. It is also to be noted that the terms “comprising,” “including,” and “having” can be used interchangeably.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all the equivalents thereof. Further, the structures, materials or acts and the equivalents thereof shall include all those described in the summary of the invention, brief description of the drawings, detailed description, abstract, and claims themselves.

Unless the meaning is clearly to the contrary, all ranges set forth herein are deemed to be inclusive of the endpoints.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the invention has been specifically disclosed by preferred embodiments, exemplary embodiments and optional features, modification and variation of the concepts herein disclosed can be resorted to by those skilled in the art, and that such modifications and variations are considered to be within the scope of this invention as defined by the appended claims. The specific embodiments provided herein are examples of useful embodiments of the invention and it will be apparent to one skilled in the art that the invention can be carried out using many variations of the devices, device components, and method steps set forth in the present description. As will be apparent to one of skill in the art, methods, and devices useful for the present methods and devices can include many optional composition and processing elements and steps.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described. Nothing herein is to be construed as an admission that the invention is not entitled to antedate such disclosure by virtue of prior invention.

All art-known functional equivalents of materials and methods are intended to be included in this disclosure. The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the invention has been specifically disclosed by preferred embodiments and optional features, modification and variation of the concepts herein disclosed can be resorted to by those skilled in the art, and that such modifications and variations are considered to be within the scope of this invention as defined by the appended claims.

In general, the terms and phrases used herein have their art-recognized meaning, which can be found by reference to standard texts, journal references and contexts known to those skilled in the art. The following definitions are provided to clarify their specific use in the context of this description.

A “system” is a combination of components operably connected to produce one or more desired functions.

A “component” is used broadly to refer to an individual part of a system.

As used herein, “chamfered” refers to a beveled edge connecting planes that would otherwise meet to form a right-angled corner. In an embodiment, the beveled edge is a 45-degree beveled edge.

“Contiguous” refers to areas, components, materials, or layers that are touching or connected throughout in an unbroken sequence.

“Proximal” and “distal” refer to the relative positions of two or more objects, planes, or surfaces. For example, an object that is close in space to a reference point relative to the position of another object is considered proximal to the reference point, whereas an object that is further away in space from a reference point relative to the position of another object is considered distal to the reference point.

The terms “direct and indirect” describe the actions or physical positions of one component relative to another component. For example, a component that “directly” acts upon or touches another component does so without intervention from an intermediary. Contrarily, a component that “indirectly” acts upon or touches another component does so through an intermediary (e.g., a third component).

The term “additive manufacturing” refers to manufacturing processes that may be used to produce functional, three-dimensional, complex objects, layer-by-layer, without molds or dies.

The universal brackets disclosed herein make various sizes of brackets readily available, which decreases the likelihood of size mismatch in a mechanical system and improves safety. The universal brackets include a universal yoke that is compatible with a variety of yoke caps, such that selection of a particular yoke cap determines the size of an opening formed when the yoke and yoke cap are joined. The universal nature of the yoke allows manufacturers and suppliers to reduce costs associated with producing and stocking parts in multiple sizes, and it allows consumers to conveniently utilize the universal yoke with different yoke caps for different projects.

The universal brackets disclosed herein are useful, for example, in systems designed to mount mudflaps to a vehicle hitch because the universal bracket can mount to ball mounts of various dimensions (e.g., 2″, 2.5″, 3″). Further, mudflap mounting systems disclosed herein optionally include (i) support arms with vertically, laterally and/or horizontally offset clamps, (ii) cylindrical clamps that allow fasteners to interact with a groove on a clamped object to prevent or limit lateral sliding, (iii) flared mudflap support rods having a shape that ensures proper assembly and prevents the rods from sliding through a clamp, (iv) a plurality of holes for securing a mudflap holder a particular distance from a center of the vehicle based on whether a narrow, standard or wide mudflap is being installed, and/or (v) mudflaps incorporating vertical and/or horizontal reinforcing ridges and ribs, which may for example allow the mudflap to be cut to a desired ground clearance.

In an aspect, a bracket comprises a yoke comprising a top member and two side members formed into a U-shape with an attachment point protruding from an external surface of each of the two side members and a yoke cap comprising a bottom member having at least two holes configured to align with each of the two side members of the yoke. In an embodiment, longitudinal axes of the attachment points are substantially parallel with a longitudinal axis of the top member. As used herein, the term “substantially” means within a small deviation that does not affect functionality as one skilled in this art area would readily recognize.

An opening formed by the joined yoke and yoke cap may have a cross section that is substantially square or substantially rectangular, and one skilled in the art will recognize that other shapes are also possible and within the scope of this disclosure, including, but not limited to, substantially trapezoidal, substantially hexagonal, substantially circular, substantially triangular, substantially rhomboidal or irregular in shape. In an embodiment, a bracket can be sandwiched around and secured to an object of a particular shape, such as a vehicle hitch, a post, a beam, a railing, a fence, a furniture leg, or the like.

In an embodiment, a yoke cap further comprises a pair of fins extending from the bottom member. For example, each of the fins may be positioned between the center of the bottom member and one of the holes of the bottom member. In an embodiment, longitudinal axes of the fins are oriented substantially parallel with longitudinal axes of the holes. In an embodiment, each of the fins is configured to abut an internal surface of one of the two side members of the yoke when the yoke and yoke cap are joined. Generally, the fins function as alignment tools and space fillers, such that larger fins reduce the size of an opening created by a bracket and smaller fins increase the size of an opening created by a bracket. Thus, selection of an appropriate yoke cap allows a user of the bracket to match the size of the bracket opening to the object enclosed. In an embodiment, the object enclosed is a ball mount of a vehicle hitch.

In an embodiment, the top member of the yoke has a substantially concave front surface. In an embodiment, a top member of the yoke is rounded to limit contact with an object in front of the bracket, such as a ball mount of a vehicle hitch.

In an embodiment, the yoke further comprises a pocket formed in a back surface of each of the side members. In an embodiment, the pocket is contiguous with the hole in the side member, which allows a nut within the pocket to be threaded onto a bolt inserted through the hole. The hole may or may not be threaded. When the hole is not threaded, manufacturing costs are decreased while strength of the connection is maintained through the nut-and-bolt interaction. As an added benefit, nuts and bolts can be easily removed and replaced in the disclosed brackets.

Generally, the bracket includes bosses, receivers, protrusions, loops, or other attachment points, which may be positioned on surfaces of the yoke and/or yoke cap, for accommodating external components. In an embodiment, the attachment points are substantially cylindrical. In an embodiment, each of the attachment points comprises at least one groove within an outer surface of the attachment point. In an embodiment, the attachment point is selected from the group consisting of a boss, a receiver, a protrusion, and a loop. In an embodiment, each of the bosses comprises a substantially conical void extending along a center axis of the bosses from a taper near the side member to an opening at the exterior surface of the boss.

In an embodiment, bottom corners of a yoke cap are chamfered.

In an embodiment, the front and/or back surface of the yoke cap is substantially planar. In an embodiment, the yoke cap comprises a first indentation in the central front-top portion of the bottom member and/or a second in the central back-bottom portion of the bottom member. The first indentation may, for example, accommodate a dropdown bar of a ball mount, whereas the second indentation may, for example, accommodate an edge of a receiver tube.

A mudflap mounting system may utilize a bracket that is disclosed herein. In an aspect, a mudflap mounting system comprises a yoke comprising a top member and two side members formed into a U-shape with an attachment point protruding from an external surface of each of the two side members, a yoke cap comprising a bottom member having holes configured to align with each of the two side members of the yoke, and at least one support arm comprising offset first and second cylindrical clamps joined by a bent arm.

This mudflap mounting system may be mounted on the male portion of a ball mounts of a vehicle hitch without impeding the ability of the vehicle hitch to carry a trailer. Further, this mounting system allows for adjustment in the mudflap ground clearance in at least two ways. First, a support arm having a particular vertical offset of the first and second cylindrical clamps can be selected. Second, a first cylindrical clamp of a support arm can be rotated on the boss to simultaneously alter the vertical and lateral position of the second cylindrical clamp. For example, when the first cylindrical clamp is rotated away from the vehicle, the mudflap will be positioned further from the vehicle and lower to the ground.

In an embodiment, each of the support arms comprises offset first and second cylindrical clamps joined by a bent arm. In an embodiment, the first and second cylindrical clamps are offset relative to one another both vertically (y) and laterally (x). In an embodiment, the first and second cylindrical clamps are also offset relative to one another horizontally (z). Thus, center lines of the first and second cylindrical clamps are offset from one another in all three dimensions. Bent arms and offset cylindrical clamps may be beneficially used to accommodate a vehicle body or bumper. Further, although the support arms may be right-handed and left-handed, they can be used on either side of the bracket or paired with like-handed arms to provide alternative configurations, such as a configuration where the support arms are tucked underneath a vehicle bumper.

In an embodiment, the first cylindrical clamp of the mudflap mounting system comprises a rounded body forming an inner bore, wherein the rounded body comprises a slit, a pair of tabs extending outwardly from edges of the slit, and a fastener hole extending through the pair of tabs, wherein areas defined by the inner bore and the fastener hole partially overlap. This overlap allows a fastener (e.g., a screw) within the fastener hole to seat in a groove of an object, such as a boss. In an embodiment, a central axis of the inner bore and a central axis of the fastener hole are substantially perpendicular to one another. When a fastener is seated in a groove of an object held by cylindrical clamp, sliding of the clamp on the object is minimized or prevented. It is contemplated that one or more fastener holes of the cylindrical clamp may be configured to allow access to a curved, rounded, square, rectangular, triangular, or irregularly shaped groove of an object to be clamped. It is further contemplated that the cylindrical clamp disclosed herein with reference to a support arm may be fabricated as a standalone clamp or as a portion of a completely different system.

In an embodiment, centers of the first and second cylindrical clamps are offset from one another in all three dimensions.

In an embodiment, a mudflap mounting system further comprises at least one rod for insertion into the second cylindrical clamp of the at least one support arm and at least one mudflap holder for securing a mudflap to the mudflap mounting system.

In an embodiment, the at least one rod comprises a flared end to prevent the rod from slipping through the second cylindrical clamp during use. Thus, during assembly, the rod can only be inserted through the second cylindrical clamp in one direction. This safety feature prevents slippage of the rod through the clamp, simplifies manufacturing and encourages proper assembly of a mudflap mounting system.

In an embodiment, a mudflap holder comprises a slit, tubular body having an inner diameter substantially equal to or slightly larger than the outer diameter of the rod. Further, an external surface of mudflap holder may include a label, such as a safety label reading “Not A Step,” and a fastener hole for passing a fastener through the mudflap holder and into the rod, thereby securing the mudflap holder and rod together. In an embodiment, a pair of flanges extends outwardly from edges of the slit and traverses the length of the tubular body. In one embodiment, each of the flanges comprises a foot extending away from the opening created by the flanges, which avoids abrasion of the mudflap. Each of the flanges comprises a plurality of fastener holes for securing a mudflap to the mudflap holder.

In an embodiment, the mudflap mounting system further comprises a mudflap having at least one vertically reinforced ridge comprising a plurality of partial holes and a plurality of reinforcing sections. In an embodiment, the mudflap mounting system further comprises horizontal ribs positioned between the partial holes and extending across a width of the mudflap.

In an aspect an improvement to a mudflap comprising a rubberized sheet, comprises at least one vertically reinforced ridge within a top edge of the rubberized sheet, the vertically reinforced ridge comprising a plurality of partial holes and a plurality of reinforcing sections, wherein the partial holes are vertically spaced to enable adjustment in mounting height. For example, during assembly, a user may select a desired height (ground clearance) for the mudflap and punch the partial holes located at the vertical position that will provide the desired mudflap height. For example, the partial holes may be punched with a hole punch tool or by driving a screw through the rubberized, mudflap. A tight fit between the rubberized mudflap and screw may help to secure the screw in place and keep it from extracting due to road and wind vibrations. The mudflap is then cut horizontally across the partial holes just above the punched holes leaving the reinforcing section above the punched holes.

In some embodiments, vertically reinforced ridges are further reinforced by horizontal ribs positioned between the partial holes and extending across the width of the mudflap. Generally, upon mounting, the horizontal ribs above and below the punched holes are compressed between flanges of the mudflap holder, which spreads the load of mudflap across the mudflap and mudflap holder rather than localizing the load to the fasteners, as in traditional systems.

In an embodiment, a plurality of vertical ribs, which may be positioned over the vertically reinforcing ridge(s) and/or horizontal ribs, create vertical channels that direct water and debris downward away from the vehicle.

In an aspect, a kit for assembling a bracket comprises a yoke comprising a top member and two side members formed into a U-shape with a boss protruding from an external surface of each of the two side members, a yoke cap comprising a bottom member having holes configured to align with each of the two side members of the yoke, and instructions for assembling the bracket. In an embodiment, a kit comprises a yoke, multiple yoke caps for accommodating objects of various sizes and instructions for assembling the bracket.

In an aspect, a kit for assembling a mudflap mounting system comprises a yoke comprising a top member and two side members formed into a U-shape with a boss protruding from an external surface of each of the two side members, a yoke cap comprising a bottom member having holes configured to align with each of the two side members of the yoke, at least one support arm comprising offset first and second cylindrical clamps joined by a bent arm, and instructions for assembling the mudflap mounting system.

In an aspect, a method of using a bracket comprises sandwiching an object with a bracket comprising a yoke comprising a top member and two side members formed into a U-shape with a boss protruding from an external surface of each of the two side members and a yoke cap comprising a bottom member having holes configured to align with each of the two side members of the yoke, [symbol] and securing the yoke and yoke cap together. In an embodiment, a method of using a bracket further comprises attaching a first cylindrical clamp of at least one support arm to the boss of the yoke. In an embodiment, a method of using a bracket further comprises inserting a rod into a second cylindrical clamp of the at least one support arm, attaching a mudflap holder to the rod, and securing a mudflap to the mudflap holder.

In an aspect, a cylindrical clamp comprises a rounded body forming an inner bore, wherein the rounded body comprises a slit, a pair of tabs extending outwardly from edges of the slit, and a fastener hole extending through the pair of tabs, wherein areas defined by the inner bore and the fastener hole partially overlap. In an embodiment, a central axis of the inner bore and a central axis of the fastener hole are substantially perpendicular to one another.

In an embodiment, a component of a bracket or mudflap mounting system comprises a material selected from the group consisting of plastic, rubber, carbon fiber, a metal, a metal alloy, and combinations thereof.

Components disclosed herein may be manufactured by techniques known in the art, including, but not limited to, laser cutting and printing, CNC machining, additive manufacturing, injection molding, casting, forging, extruding and the like.

In an embodiment, a kit comprises one or more of the components disclosed herein, instructions for using and assembling the component(s), and optionally one or more fasteners.

### BRIEF DESCRIPTION OF THE SEVERAL VIEWS OF THE DRAWINGS

FIG. 1 shows a front perspective view of a yoke, according to an embodiment of the invention.

FIG. 2A shows a back plan view of the yoke of FIG. 1, according to an embodiment of the invention.

FIG. 2B shows a back perspective view of the yoke of FIG. 1, according to an embodiment of the invention.

FIG. 3A shows a top plan view of the yoke of FIGS. 1, 2A, and 2B, according to an embodiment of the invention.

FIG. 3B shows a bottom plan view of the yoke of FIGS. 1, 2A, and 2B, according to an embodiment of the invention.

FIG. 4A shows a right-side plan view of the yoke of FIGS. 1, 2A, and 2B, according to an embodiment of the invention.

FIG. 4B shows a left side plan view of the yoke of FIGS. 1, 2A, and 2B, according to an embodiment of the invention.

FIG. 5 shows a front plan partial cutaway view of the yoke of FIGS. 1-4B, according to an embodiment of the invention.

FIG. 6A1 shows a front perspective view and 6A2 shows a back perspective view of a yoke cap, according to an embodiment of the invention.

FIG. 6B1 shows a front perspective view and 6B2 shows a back perspective view of a yoke cap, according to an embodiment of the invention.

FIG. 6C1 shows a front perspective view and 6C2 shows a back perspective view of a yoke cap, according to an embodiment of the invention.

FIG. 7A shows a front plan view of the yoke cap of FIGS. 6A1 and 6A2 mated with the yoke of FIGS. 1-5, according to an embodiment of the invention.

FIG. 7B shows a front plan view of the yoke cap of FIGS. 6B1 and 6B2 mated with the yoke of FIGS. 1-5, according to an embodiment of the invention.

FIG. 7C shows a front plan view of the yoke cap of FIGS. 6C1 and 6C2 mated with the yoke of FIGS. 1-5, according to an embodiment of the invention.

FIG. 8A shows a back plan view of the yoke cap of FIGS. 6A1 and 6A2 mated with the yoke of FIGS. 1-5, according to an embodiment of the invention.

FIG. 8B shows a back plan view of the yoke cap of FIGS. 6B1 and 6B2 mated with the yoke of FIGS. 1-5, according to an embodiment of the invention.

FIG. 8C shows a back plan view of the yoke cap of FIGS. 6C1 and 6C2 mated with the yoke of FIGS. 1-5, according to an embodiment of the invention.

FIG. 9A1 shows a right-side plan view of the yoke cap of FIGS. 6A1 and 6A2 mated with the yoke of FIGS. 1-5, according to an embodiment of the invention.

FIG. 9A2 shows a left side plan view of the yoke cap of FIGS. 6A1 and 6A2 mated with the yoke of FIGS. 1-5, according to an embodiment of the invention.

FIG. 9B1 shows a right-side plan view of the yoke cap of FIGS. 6B1 and 6B2 mated with the yoke of FIGS. 1-5, according to an embodiment of the invention.

FIG. 9B2 shows a left side plan view of the yoke cap of FIGS. 6B1 and 6B2 mated with the yoke of FIGS. 1-5, according to an embodiment of the invention.

FIG. 9C1 shows a right-side plan view of the yoke cap of FIGS. 6C1 and 6C2 mated with the yoke of FIGS. 1-5, according to an embodiment of the invention.

FIG. 9C2 shows a left side plan view of the yoke cap of FIGS. 6C1 and 6C2 mated with the yoke of FIGS. 1-5, according to an embodiment of the invention.

FIG. 10A shows a back plan view of the yoke of FIGS. 1-5 having support arms mounted on bosses of the yoke, according to an embodiment of the invention.

FIG. 10B shows a back plan view of the yoke of FIGS. 1-5 having support arms mounted in a reverse position on bosses of the yoke, according to an embodiment of the invention.

FIG. 11 shows a top plan view of the embodiment shown in FIG. 10A mounted on a ball mount, according to an embodiment of the invention.

FIG. 12A shows a right-side plan view of the embodiment shown in FIGS. 10 A and 11, according to an embodiment of the invention.

FIG. 12B shows a left side plan view of the embodiment shown in FIGS. 10A and 11, according to an embodiment of the invention.

FIG. 13 shows a left side partial cutaway plan view of the embodiment shown in FIGS. 10A and 11, according to an embodiment of the invention.

FIG. 14A shows a front perspective view of a mudflap mounting system, according to an embodiment of the invention.

FIG. 14B shows a back perspective view of a mudflap mounting system shown in FIG. 14A, according to an embodiment of the invention.

FIG. 15A shows a front perspective view of a mudflap holder, according to an embodiment of the invention.

FIG. 15B shows a side plan view of a mudflap holder, according to an embodiment of the invention.

FIG. 16A shows a front plan view of a mudflap comprising a corrugated form factor, according to an embodiment of the invention.

FIG. 16B shows a side plan view of a mudflap comprising a corrugated form factor, according to an embodiment of the invention.

FIG. 16C shows a back side plan view of a mudflap comprising a corrugated form factor, according to an embodiment of the invention.

FIG. 16D shows a cross section side view detail of a portion of FIG. 16B of a mudflap comprising a corrugated form factor, according to an embodiment of the invention.

FIG. 17A shows a bolt used with a nut to connect a yoke with a yoke cap according to an embodiment of the invention.

FIG. 17B shows a nut used with a bolt to connect a yoke with a yoke cap according to an embodiment of the invention.

To assist in the understanding of the present disclosure the following list of components and associated numbering found in the drawings is provided herein:

Table of Components

| Component | # |
|---|---|
| yoke | 100 |
| top member | 102 |
| first side member | 104A |
| second side member | 104B |
| first boss | 106A |
| second boss | 106B |
| first hole | 108A |
| second hole | 108B |
| first pocket | 200A |
| second pocket | 200B |
| front surface | 300 |
| first groove | 302A |
| second groove | 302B |
| axis | 500 |
| axis | 502 |
| first conical void | 504A |
| second conical void | 504B |
| first opening | 506A |
| second opening | 506B |
| yoke cap | 600A |
| yoke cap | 600B |
| yoke cap | 600C |
| bottom member | 602A |
| bottom member | 602B |
| bottom member | 602C |
| first hole | 604A1 |
| second hole | 604A2 |
| first hole | 604B1 |
| second hole | 604B2 |
| first hole | 604C1 |
| second hole | 604C2 |
| first indentation | 608A |
| first indentation | 608B |
| first indentation | 608C |
| second indentation | 610A |
| second indentation | 610B |
| second indentation | 610C |
| fins | 612B |
| fins | 612C |
| axis | 614B |
| axis | 616C |
| bolt | 618 |
| nut | 620 |
| bracket | 700A |
| bracket | 700B |
| bracket | 700C |
| opening | 702A |
| opening | 702B |
| opening | 702C |
| gap | 703 |
| corners | 704 |
| marking | 800A |
| marking | 800B |
| marking | 800C |
| support arm | 1000 |
| first cylindrical clamp | 1002 |
| center line | 1003 |
| second cylindrical clamp | 1004 |
| center line | 1005 |
| bent arm | 1006 |
| screw | 1008 |
| vehicle hitch | 1010 |
| ball mount | 1012 |
| slit | 1200 |
| rounded body | 1300 |
| inner bore | 1302 |
| tab | 1304 |
| fastener hole | 1306 |
| axis | 1308 |
| axis | 1310 |
| mudflap mounting system | 1400 |
| rod | 1404 |
| mudflap holder | 1406 |
| mudflap | 1408 |
| flared end | 1410 |
| slit tubular body | 1500 |
| label | 1502 |
| fastener hole | 1504 |
| flange | 1506 |
| slit | 1508 |
| foot | 1510 |
| front surface | 1602 |
| back surface | 1604 |
| ridges | 1608 |
| partial hole | 1610 |
| reinforcing section | 1612 |
| horizontal rib | 1614 |
| vertical rib | 1616 |

### DETAILED DESCRIPTION

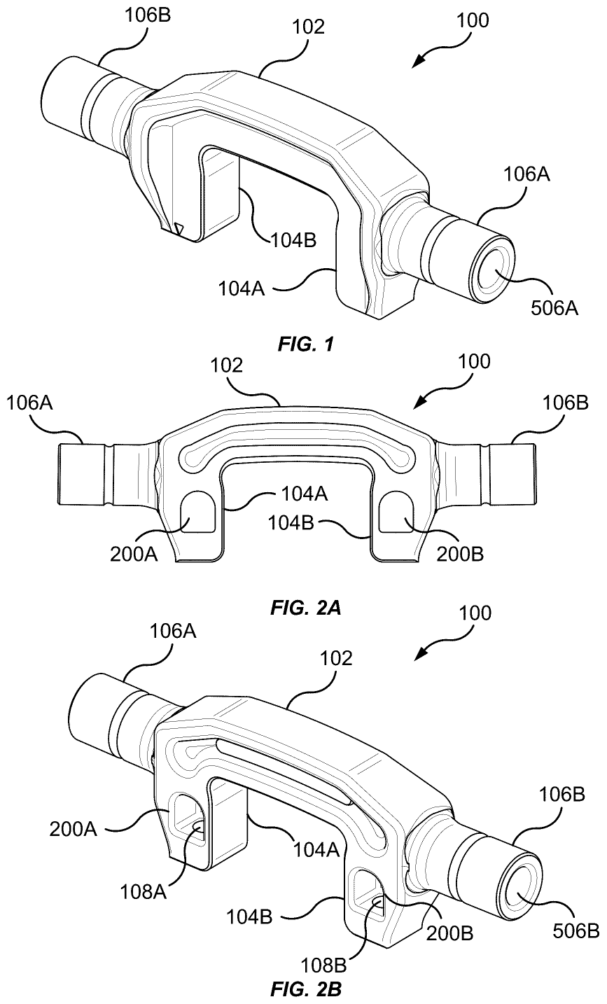

Referring now to the Figures, like reference numerals and names refer to structurally and/or functionally similar elements thereof, and if objects depicted in the figures that are covered by another object, as well as the tag line for the element number thereto, may be shown in dashed lines. FIG. 1 shows a front perspective view of a yoke, according to an embodiment of the invention. FIG. 2A shows a back plan view of the yoke of FIG. 1, according to an embodiment of the invention, and FIG. 2B shows a back perspective view of the yoke of FIG. 1, according to an embodiment of the invention. Referring now to FIGS. 1, 2A, and 2B, yoke 100 comprises a top member 102 and a first side member 104A and a second side member 104B, which together form a substantially u-shaped object. First boss 106A protrudes from an external surface of first side member 104A and second boss 106B protrudes from an external surface of second side member 104B. As shown, bosses 106A and 106B are substantially cylindrical. FIGS. 2A and 2B show a first pocket 200A formed in a back surface of first side member 104A, and a second pocket 200B formed in a back surface of second side member 104B. Generally, first and second pockets 200A and 200B are contiguous with the first hole 108A and second hole 108B within side members 104A and 104B respectively such that a nut 620 within first and second pockets 200A and 200B may be threaded onto a bolt 618 (see FIGS. 17A and 17B) inserted through the first and second holes 108A and 108B, which may or may not be threaded. This configuration allows nuts and bolts to be easily replaced and avoids any requirement to thread the hole, which decreases manufacturing costs while maintaining strength through the nut-and-bolt interaction.

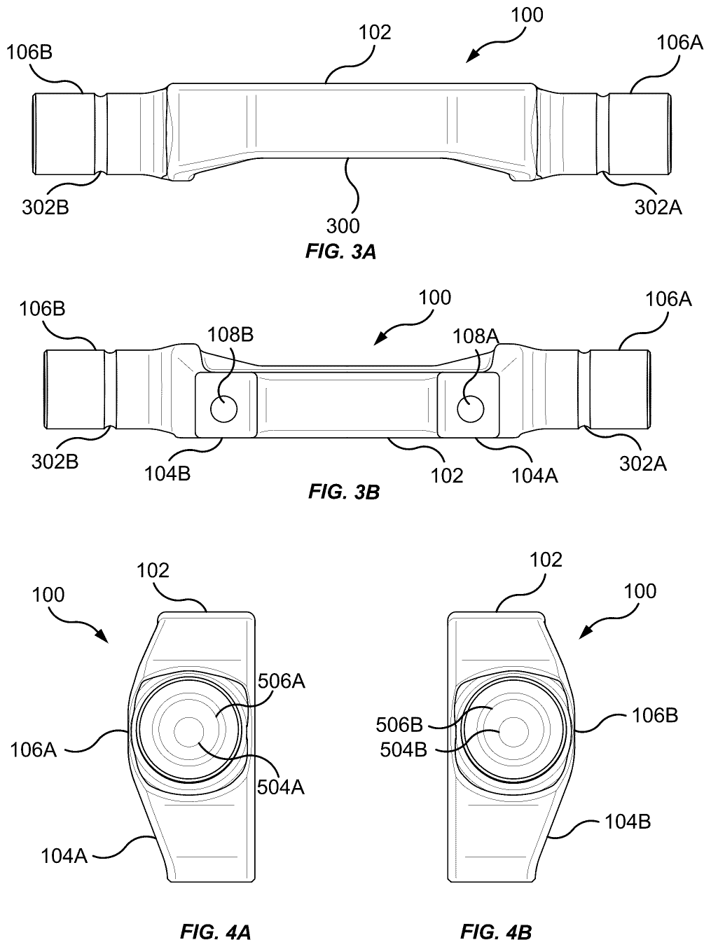

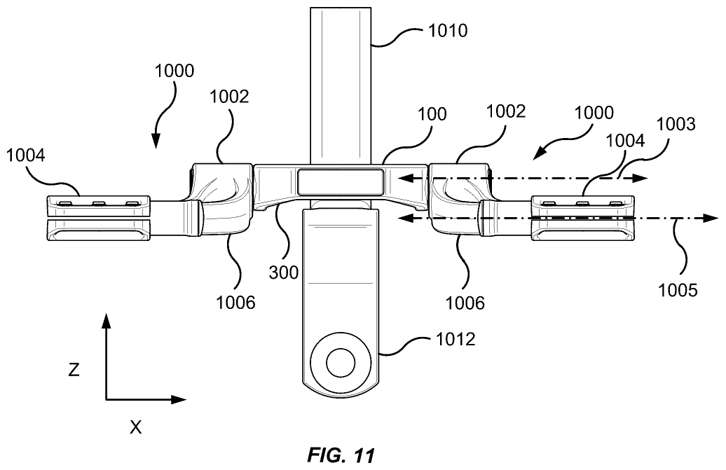

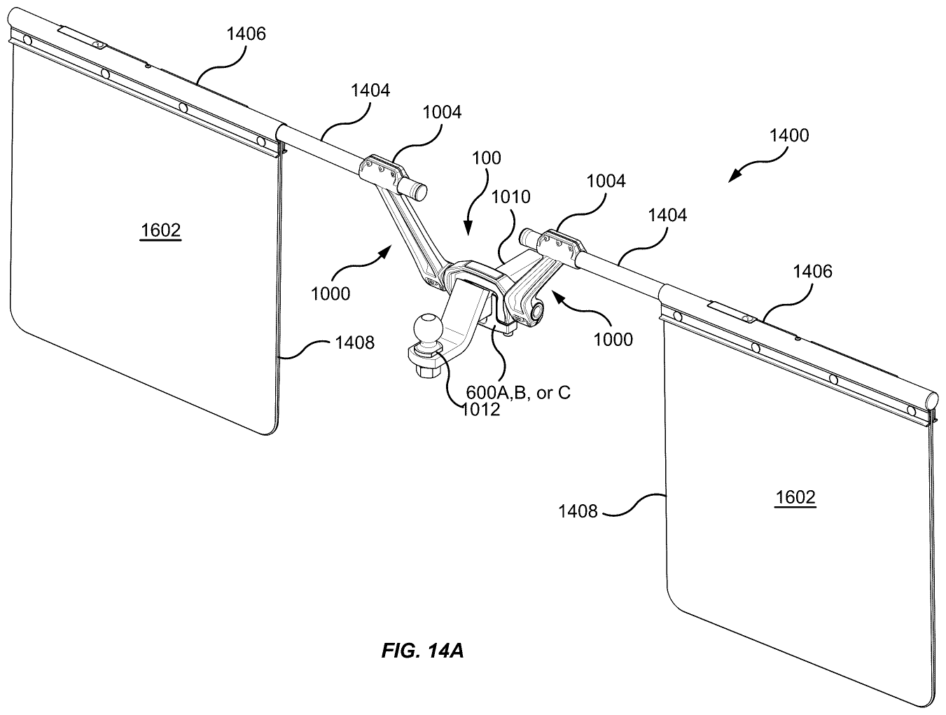

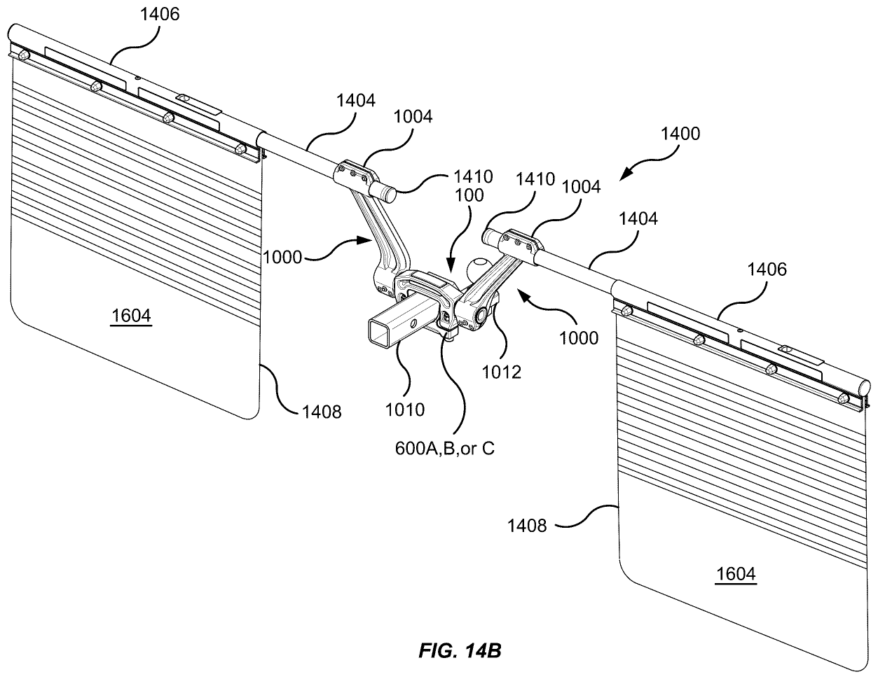

FIG. 3A shows a top plan view of the yoke of FIGS. 1, 2A, and 2B, according to an embodiment of the invention, and FIG. 3B shows a bottom plan view of the yoke of FIGS. 1, 2A, and 2B, according to an embodiment of the invention. Referring now to FIGS. 3A and 3B, top member 102 of yoke 100 has a substantially concave front surface 300. When yoke 100 is used on a vehicle hitch 1010, this feature helps to limit contact between yoke 100 and a ball mount 1012 of the vehicle hitch 1010 (see FIGS. 11 and 14A). In the embodiment shown, each of the first and second bosses 106A and 106B comprises at least one first groove 302A within an outer surface of first boss 106A and at least one second groove 302B within an outer surface of second boss 106B. First and second grooves 302A and 302B may partially or completely encircle first and second bosses 106A and 106B. First and second grooves 302A and 302B may be used to retain the lateral position of a screw 1008 on first and second bosses 106A and 106B. The screw 1008, for example, may be used in conjunction with cylindrical clamps 1002, 1004 and fastener hole 1306 (see FIG. 13). This prevents lateral movement of the support arms 1000 but allows for rotation of the support arms 1000 about the first and second bosses 106A and 106B.

FIG. 4A shows a right-side plan view of the yoke of FIGS. 1, 2A, and 2B, according to an embodiment of the invention, and FIG. 4B shows a left side plan view of the yoke of FIGS. 1, 2A, and 2B, according to an embodiment of the invention. Referring now to FIGS. 4A and 4B, when yoke 100 is viewed from the front, first side member 104A is the right side and second side member 104B is the left side.

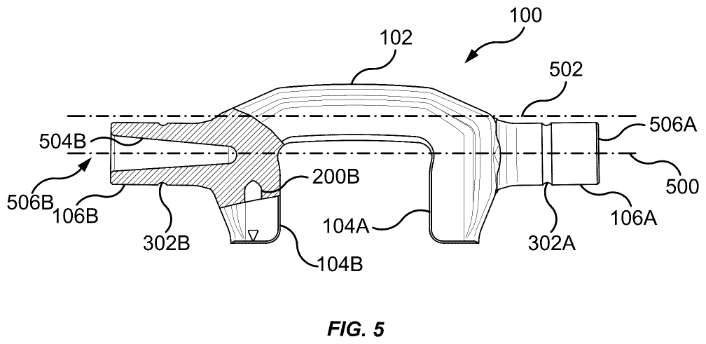

FIG. 5 shows a front plan partial cutaway view of the yoke of FIGS. 1-4B, according to an embodiment of the invention. Referring now to FIG. 5, in the embodiment shown, longitudinal axis 500 of first and second bosses 106A and 106B is substantially parallel with a longitudinal axis 502 of top member 102. The partial cutaway section of second boss 106B shows a substantially second conical void 504B extending along longitudinal axis 500 from a taper beginning proximally from second side member 104B to a distal second opening 506B at the exterior surface of second boss 106B. A corresponding first conical void 504A extending along longitudinal axis 500 from a taper beginning proximally from first side member 104A to a distal second opening 506A at the exterior surface of first boss 106A. Also shown in the partial cutaway section is second pocket 200B formed in the back surface of second side member 104B.

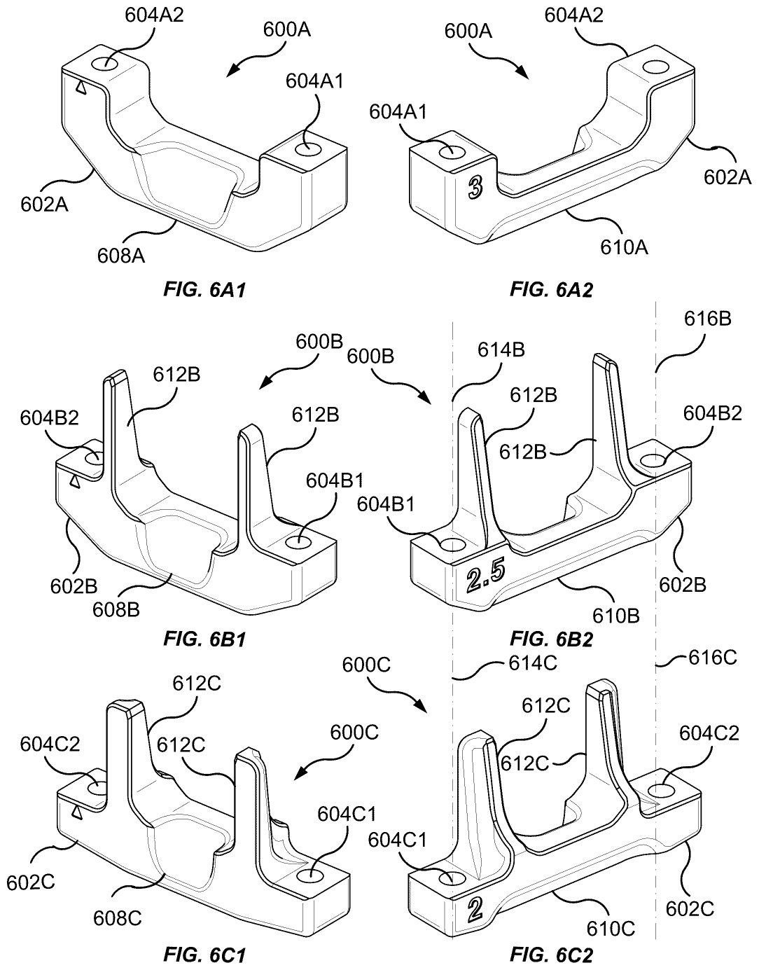

FIG. 6A1 shows a front perspective view and 6A2 shows a back perspective view of a yoke cap, according to an embodiment of the invention, FIG. 6B1 shows a front perspective view and 6B2 shows a back perspective view of a yoke cap, according to an embodiment of the invention, and FIG. 6C1 shows a front perspective view and 6C2 shows a back perspective view of a yoke cap, according to an embodiment of the invention. Referring now to FIGS. 6A1 and 6A2, 6B1 and 6B2, and 6C1 and 6C2, front left (6A1, 6B1, and 6C1) and back right (6A2, 6B2, and 6C2) perspective views of various yoke caps 600A, 600B, and 600C are shown. Each yoke cap 600A, 600B, and 600C are substantially u-shaped and comprises a bottom member 602A, 602B, and 602C having first hole 604A1 and second hole 604A2, first hole 604B1 and second hole 604B2, and first hole 604C1 and second hole 604C2 respectively that are configured to align with each of the two side members 104A and 104B and holes 108A and 108B of yoke 100. A nut 620 is placed in first pocket 200A and a bolt 618 (see FIGS. 17A and 17B) is passed through first holes 604A1, 604B1, or 604C1 and then through first hole 108A and tightened into nut 620. Likewise, A nut 620 is placed in second pocket 200B and a bolt 618 is passed through second holes 604A2, 604B2, or 604C2 and then through second hole 108B and tightened into nut 620. Thus, yoke 100 and yoke cap 600A, 600B, or 600C attached together clamp tight onto vehicle hitch 1010. Optionally, corners of bottom members 602A, 602B, and 602C are chamfered. In the embodiments shown, front and back surfaces of yoke caps 600A, 600B, and 600C are substantially planar with a first indentations 608A, 608B, and 608C in the central front-top portion of bottom members 602A, 602B, and 602C respectively, and second indentations 610A, 610B, and 610C in the central back-bottom portion of bottom members 602A, 602B, and 602C. First indentations 608A, 608B, and 608C may, for example, accommodate a ball mount 1012 of a ball mount 1012 (see FIGS. 11, 14A, and 14B), whereas second indentations 610A, 610B, and 610C may, for example, accommodate an edge of a receiver tube.

Yoke caps 600B and 600C further comprise a pair of fins 612b and 612C respectively extending from bottom members 602B and 602C, respectively. In the embodiments shown, fins 612b and 612C are positioned between a center of bottom members 602B and 602C and holes 604B1 and 604B2, and 604C1 and 604C2, respectively. Also, in the embodiments shown, longitudinal axes 614b and 614C of fins 612B and 612C are oriented substantially parallel with longitudinal axes 616B and 616C of holes 604B1/604B2 and 604C1/604C2 respectively. As described in greater detail hereinafter, fins 612B and 612C are sized and configured to accommodate objects of assorted sizes.

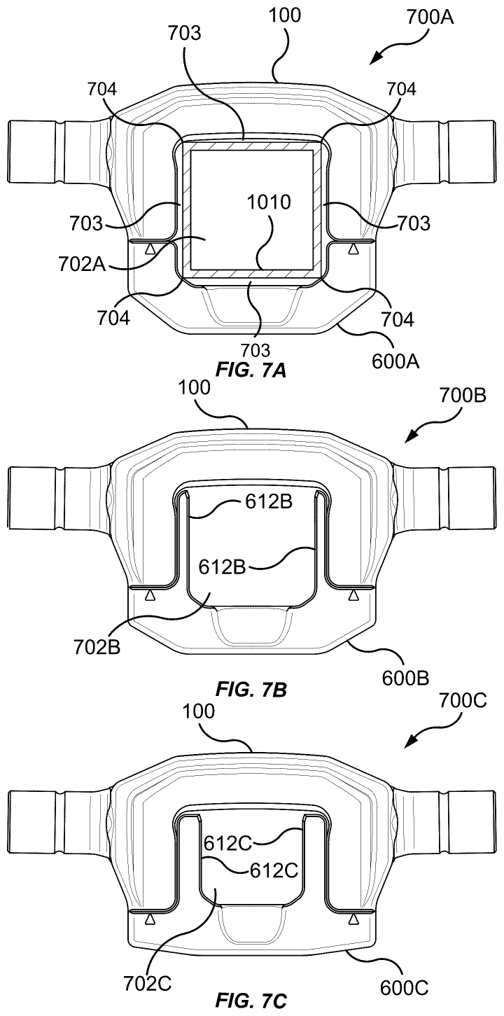

FIG. 7A shows a front plan view of the yoke cap of FIGS. 6A1 and 6A2 mated with the yoke of FIGS. 1-5, and FIG. 7B shows a front plan view of the yoke cap of FIGS. 6B1 and 6B2 mated with the yoke of FIGS. 1-5, and FIG. 7C shows a front plan view of the yoke cap of FIGS. 6C1 and 6C2 mated with the yoke of FIGS. 1-5, according to an embodiment of the invention. Referring now to FIGS. 7A, 7B, and 7C, front plan views of yoke caps 600A, 600B, and 600C are shown mated with yoke 100 to form bracket 700A, bracket 700B, and bracket 700C. Also shown in FIG. 7A in cross section is vehicle hitch 1010 (see also FIGS. 11, 14A and 14B). Brackets 700A, 700B, and 700C clamp onto a rectangular or square shape vehicle hitch 1010 in such a way that only the corners 704 of the rectangular or square shape vehicle hitch 1010 are in contact with the yoke 100 and the yoke caps 600A, 600B, and 600C and not the left or right sides or top or bottom sides of yoke 100 and the yoke caps 600A, 600B, and 600C. as shown by gaps 703 between the exterior walls of the rectangular or square shape vehicle hitch 1010 and the interior walls of the yoke 100 and the interior walls of yoke cap 600A.

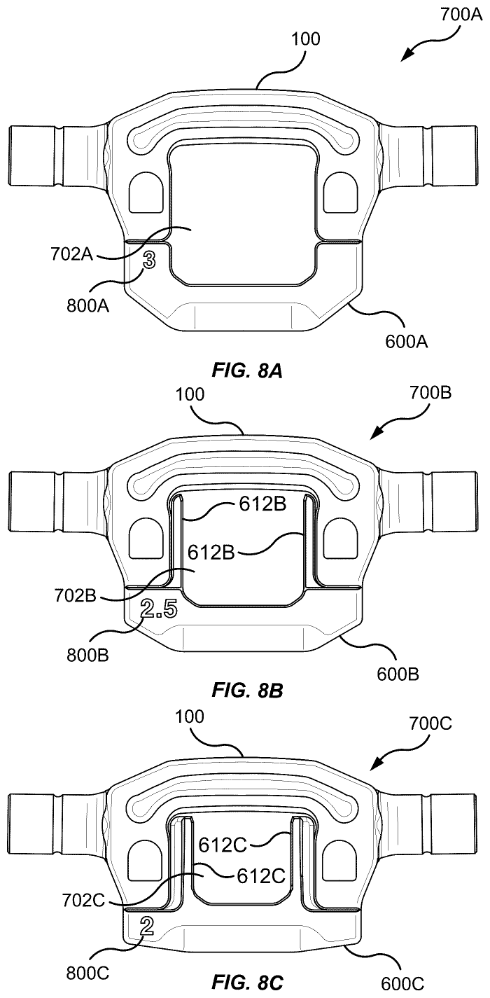

FIG. 8A shows a back plan view of the yoke cap of FIGS. 6A1 and 6A2 mated with the yoke of FIGS. 1-5, FIG. 8B shows a back plan view of the yoke cap of FIGS. 6B1 and 6B2 mated with the yoke of FIGS. 1-5, FIG. 8C shows a back plan views of the yoke cap of FIGS. 6C1 and 6C2 mated with the yoke of FIGS. 1-5, according to an embodiment of the invention. Referring now to FIGS. 8A, 8B, and 8C, back plan views of yoke caps 600A, 600B, and 600C are shown mated with yoke 100 to form bracket 700A, bracket 700B, and bracket 700C.

As shown in FIGS. 7A to 8C inclusively, fins 612B and 612C are configured to abut an internal surfaces of two side members 104A and 104B of yoke 100 when yoke 100 and yoke cap 600B and 600C are joined to form brackets 700B and 700C, respectively. Fins 612B and 612C help to align brackets 700B and 700C with a component such as a ball mount 1012 of a vehicle hitch 1010. In the embodiments shown, openings 702A, 702B and 702C formed by brackets 700A, 700B, and 700C have substantially square or substantially rectangular cross sections of 2, 2.5, and 3 inches, as indicated by the markings 800A, 800B, and 800C respectively on the back surfaces of 600A, 600B, and 600C. Generally speaking, the size of openings 702A, 702B and 702C is reduced as the width of fins 612A and 612B increases.

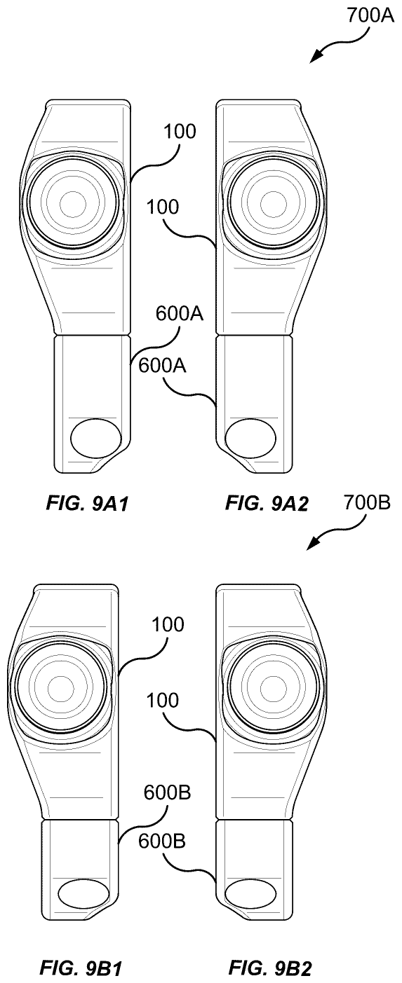

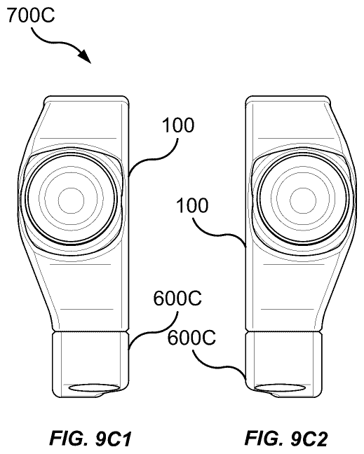

FIG. 9A1 shows a right-side plan view of the yoke cap of FIGS. 6A1 and 6A2 mated with the yoke of FIGS. 1-5, and FIG. 9A2 shows a left side plan view of the yoke cap of FIGS. 6A1 and 6A2 mated with the yoke of FIGS. 1-5, according to an embodiment of the invention. FIG. 9B1 shows a right-side plan view of the yoke cap of FIGS. 6B1 and 6B2 mated with the yoke of FIGS. 1-5, and FIG. 9B2 shows a left side plan view of the yoke cap of FIGS. 6B1 and 6B2 mated with the yoke of FIGS. 1-5, according to an embodiment of the invention. FIG. 9C1 shows a right-side plan view of the yoke cap of FIGS. 6C1 and 6C2 mated with the yoke of FIGS. 1-5, and according to an embodiment of the invention. Referring now to FIGS. 9A1 and 9A2, FIGS. 9B1 and 9B2, and FIGS. 9C1 and 9C2, side plan views of the yoke caps 600A, 600B, and 600C are shown mated with yoke 100 to form bracket 700A, bracket 700B, and bracket 700C. In the embodiments shown, corners of the yoke caps 600A, 600B, and 600C are chamfered.

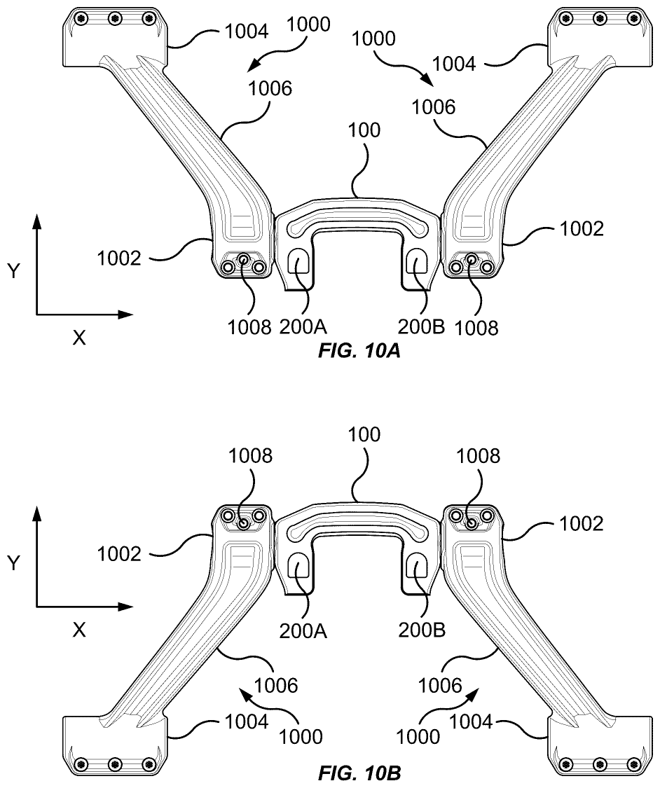

FIG. 10A shows a back plan view of the yoke of FIGS. 1-5 having support arms mounted on bosses of the yoke, FIG. 10B shows a back plan view of the yoke of FIGS. 1-5 having support arms mounted in a reverse position on bosses of the yoke, and FIG. 11 shows a top plan view of the embodiment shown in FIG. 10A mounted on a ball mount 1012, according to an embodiment of the invention. Referring now to FIGS. 10A, 10B, and 11, a back plan view of yoke 100 is shown having support arms 1000 mounted on bosses 106A and 106B of yoke 100. Each of support arms 1000 comprises a first cylindrical clamp 1002 and a second cylindrical clamp 1004 joined by a bent arm 1006. As shown in the embodiments of FIGS. 10A and 10B, first and second cylindrical clamps 1002, 1004 are offset relative to one another both vertically (y) and laterally (x). The top plan view of FIG. 11, showing the embodiment of FIG. 10A, further illustrates that the first and second cylindrical clamps 1002, 1004 are offset relative to one another horizontally (z), as shown by the pair of dashed arrows. Thus, the center lines 1003, 1005 of first and second cylindrical clamps 1002, 1004 are offset from one another in all three dimensions. Bent arms 1006 and offset first and second cylindrical clamps 1002, 1004 may be beneficially used to accommodate a vehicle body or bumper. Further, although support arms 1000 are right-handed and left-handed, they can be switched paired with like-handed arms to provide alternative configurations, such as a configuration where the support arms are tucked underneath a vehicle bumper. In addition, support arms 1000 may be rotated in various desired angles with respect to yoke 100 by way of the first cylindrical clamps 1002 to accommodate various vehicle configurations.

In the embodiment shown in FIGS. 10A, 10B, and 11, screws 1008 passing through fastener hole 1306 (see FIG. 13) of first and second cylindrical clamps 1002, 1004 engages with grooves 302A and 302B (see FIG. 3) on bosses 106A and 106B 1000. This security feature inhibits movement of support arms 1000 during use.

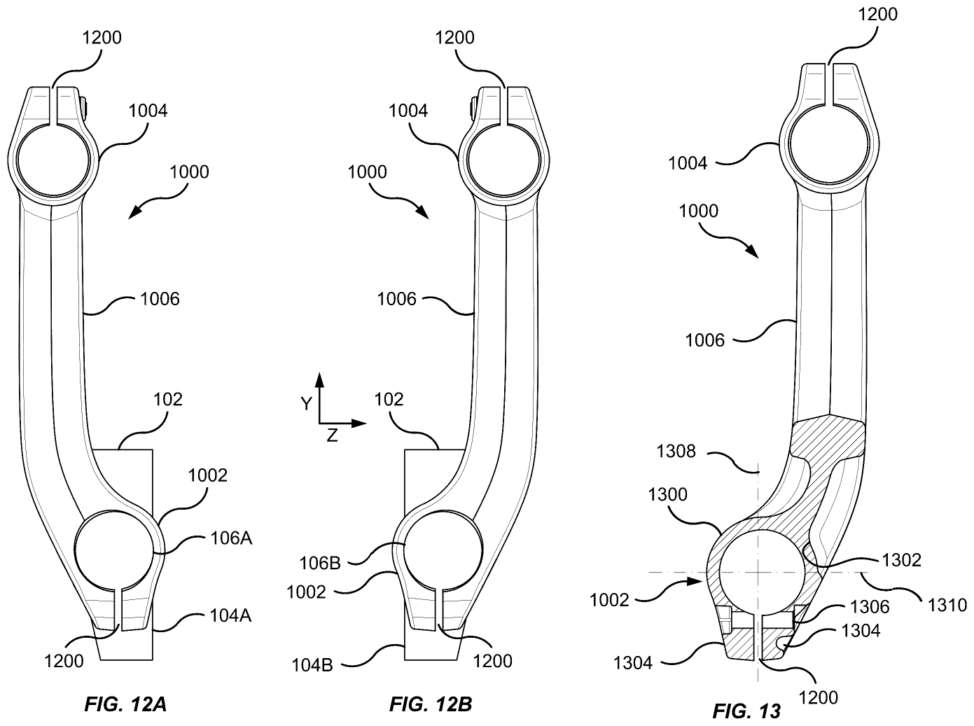

FIG. 12A shows a right-side plan view of the embodiment shown in FIGS. 10A and 11, according to an embodiment of the invention, and FIG. 12B shows a left side plan view of the embodiment shown in FIGS. 10A and 11, according to an embodiment of the invention. Referring now to FIGS. 12A and 12B, the horizontally (z) offset positions of the first and second cylindrical clamps 1002, 1004 is evident, and slits 1200 within first and second cylindrical clamps 1002, 1004 are also visible.

FIG. 13 shows a left side partial cutaway plan view of the embodiment shown in FIGS. 10A and 11, according to an embodiment of the invention. Referring now to FIG. 13, first cylindrical clamp 1002 comprises a rounded body 1300 forming an inner bore 1302. As shown in the cutaway portion, rounded body 1300 comprises a slit 1200, a pair of tabs 1304 extending outwardly from edges of slit 1200 and a fastener hole 1306 extending through the pair of tabs 1304. Areas defined by inner bore 1302 and fastener hole 1306 partially overlap, which allows a fastener (e.g., screw 1008) within fastener hole 1306 to seat in first groove 302 of first boss 106A. In the embodiment shown, a central vertical axis 1308 of the inner bore 1302 and a central horizontal axis 1310 of the fastener hole 1306 are substantially perpendicular to one another. When a fastener such as screw 1008 is seated in first groove 302 of an object held by first cylindrical clamp 1002, sliding of the first cylindrical clamp 1002 on the object is minimized or prevented. It is contemplated that one or more fastener holes 1306 of the first cylindrical clamp 1002 may be configured to allow access to a curved, rounded, square, rectangular, triangular, or irregularly shaped first groove 302 of an object to be clamped. It is further contemplated that the first cylindrical clamp 1002 disclosed herein with reference to a support arm 1000 may be fabricated on both ends of the support arm 1000, as a stand-alone clamp, or as a portion of a completely different system.

FIG. 14A shows a front perspective view of a mudflap mounting system, according to an embodiment of the invention, and FIG. 14B shows a back perspective view of a mudflap mounting system shown in FIG. 14A, according to an embodiment of the invention. Referring now to FIGS. 14A and 14B, shown is a mudflap mounting system 1400 mounted on a ball mount 1012 of a vehicle hitch 1010. Mudflap mounting system 1400 comprises yoke 100, yoke caps 600A, 600B, or 600C, support arms 1000, rods 1404 for insertion into the second cylindrical clamps 1004 of support arms 1000, mudflap holders 1406 and mudflaps 1408.

In an embodiment, rods 1404 comprises a flared end 1410 to prevent the rods 1404 from slipping through second cylindrical clamps 1004 during use. Thus, during assembly, rods 1404 can only be inserted through second cylindrical clamps 1004 in one direction until the flared end abuts against the second cylindrical clamps 1004 which is from the bracket side in the configuration shown in FIGS. 14A/14B. This safety feature prevents slippage of the rods 1404 through the second cylindrical clamps 1004, simplifies manufacturing, and encourages proper assembly of mudflap mounting system 1400.

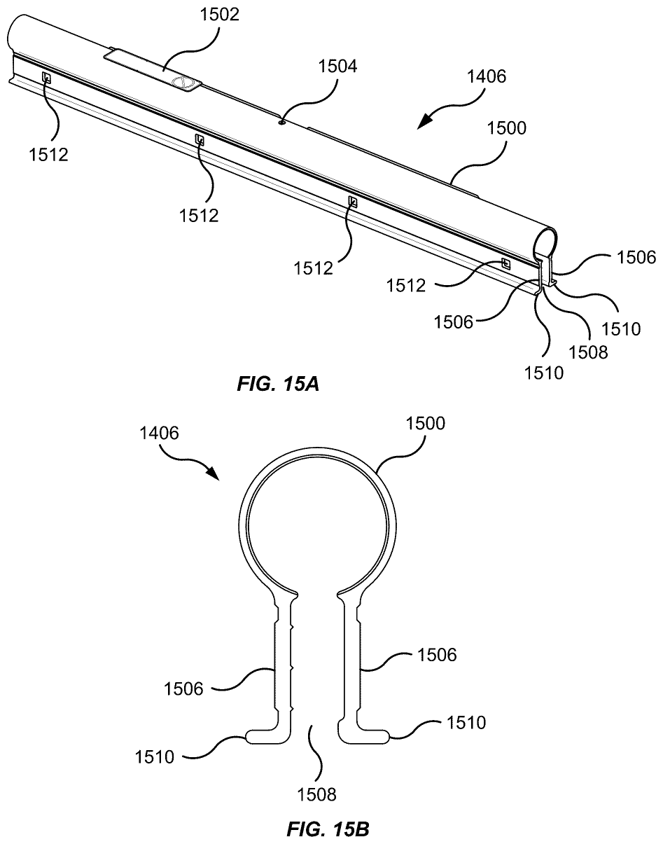

FIG. 15A shows a front perspective view of a mudflap holder, according to an embodiment of the invention, and FIG. 15B shows a side plan view of a mudflap holder, according to an embodiment of the invention. Referring now to FIGS. 15A and 15B, mudflap holder 1406 comprises a slit tubular body 1500 having an inner diameter substantially equal to or slightly larger than an outer diameter of rods 1404. Further, an external surface of mudflap holder 1406 may include a label 1502, such as a safety label reading “Not A Step”, and a fastener hole 1504 for passing a fastener through mudflap holder 1406 and into rod 1404, thereby securing the mudflap holder 1406 and rod 1404 together. A pair of flanges 1506 extends outwardly from edges of the slit 1508 and traverses the length of slit tubular body 1500. In the embodiment shown, each of flanges 1506 comprises a foot 1510 extending away from the opening created by the flanges 1506, which avoids abrasion of mudflaps 1408. Each of the flanges 1506 comprises a plurality of fastener holes 1512 for securing mudflaps 1408 to mudflap holders 1406.

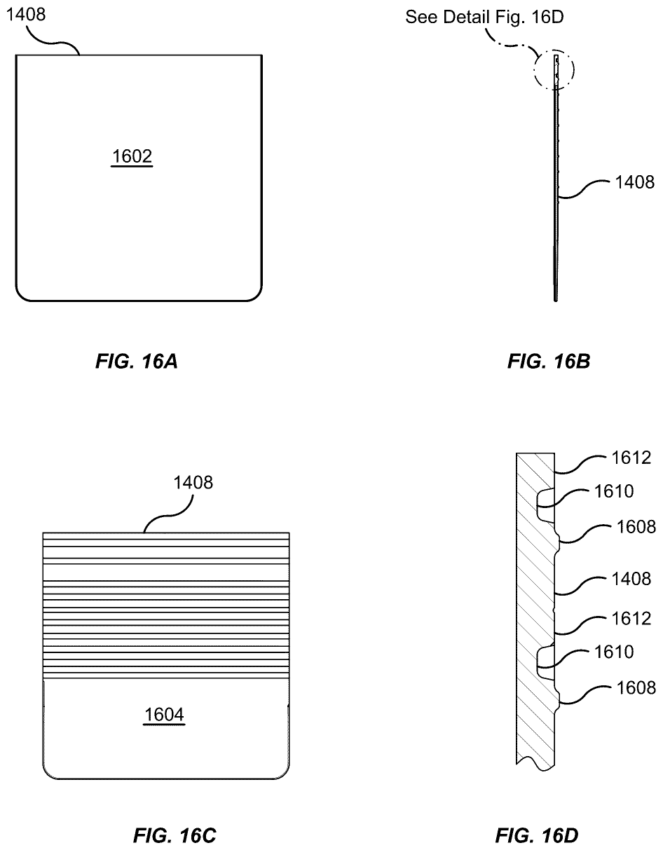

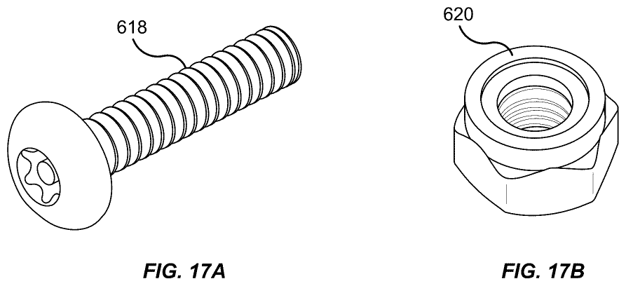

FIG. 16A shows a front plan view of a mudflap comprising a corrugated form factor, according to an embodiment of the invention, and FIG. 16B shows a side plan view of a mudflap comprising a corrugated form factor, according to an embodiment of the invention, and FIG. 16C shows a back side plan view of a mudflap comprising a corrugated form factor, according to an embodiment of the invention, and FIG. 16D shows a side view detail of a first portion of FIG. 16B of a mudflap comprising a corrugated form factor, according to an embodiment of the invention. Referring now to FIGS. 16A-16D, mudflap 1408 is a substantially rectangular sheet comprising a smooth, rubberized front surface 1602 and a back surface 1604 comprising a series of horizontally reinforced ridges 1608 configured to align with fastener holes 1512 of mudflap holder 1406. The detailed illustration shown in FIG. 16D of horizontally reinforced ridge 1608 shows a plurality of partial holes 1610 aligned vertically with a plurality of reinforcing sections 1612. During assembly, a user selects a desired height (ground clearance) for mudflap 1408 and punches the partial holes 1610 located at the vertical position that will provide the desired mudflap height. For example, partial holes 1610 may be punched with a hole punch tool or by driving a screw through the rubberized mudflap 1408. A tight fit between the rubberized mudflap 1408 and screw may help to secure the screw in place and keep it from extracting due to road and wind vibrations. Mudflap 1408 is then cut horizontally across the partial holes 1610 just above the punched holes 1610 leaving the reinforcing section 1612 above the punched holes. Generally, upon mounting, horizontal ribs 1608 above and below the punched holes are compressed between flanges 1506, which spreads the load of mudflap 1408 across the mudflap 1408 and mudflap holder 1406 rather than localizing the load to the fasteners, as in traditional systems.

FIGS. 17A and 17B show the bolt 618 and nut 620 used to connect the yoke 100 with the yoke cap 600A, 600B, or 600C.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It will be understood by those skilled in the art that many changes in construction and widely differing embodiments and applications will suggest themselves without departing from the scope of the disclosed subject matter.

What is claimed is:

1. A universal bracket comprising:
a yoke, the yoke comprising:
a top member, a first side member, and a second side member, the yoke having a substantially u-shape;
the first side member having a first pocket and a first hole extending from the first pocket through the first side member; and
the second side member having a second pocket and a second hole extending from the second pocket through the second side member; and
a first yoke cap having a substantially u-shape configured to attach to the yoke, the first yoke cap comprising:
a bottom member having a third hole through a proximal end thereof and a fourth hole through a distal end thereof;
wherein the yoke and the first yoke cap are configured to attach together through an alignment of the first hole with the third hole and an alignment of the second hole with the fourth hole and forming a substantially square opening between the yoke and the first yoke cap.

2. The universal bracket according to claim 1 further comprising:
a square vehicle hitch wherein the yoke is placed on a top of the vehicle hitch and the first yoke cap is placed on a bottom of the vehicle hitch so that the vehicle hitch is within the square opening;
a first bolt passed through the third hole and the first hole and tightened to a first nut within the first pocket; and
a second bolt passed through the fourth hole and the second hole and tightened to a second nut within the second pocket;
wherein only a four corners of the vehicle hitch are in contact with the yoke and the first yoke cap when the first and second bolts are tightened to the first and second nuts.

3. The universal bracket according to claim 2 further comprising:
a second yoke cap substituted for the first yoke cap wherein the second yoke cap has a first pair of fins that extend from a bottom member that fit inside of the first side member and the second side member forming a substantially rectangular opening between the yoke and the second yoke cap to accommodate a rectangular vehicle hitch.

4. The universal bracket according to claim 1 further comprising:
a first boss extending from the first side member;
a second boss extending from the second side member;
a first bent arm attached to the first boss at a proximal end of the first bent arm; and
a second bent arm attached to the second boss at a proximal end of the second bent arm;
wherein a distal end of the first bent arm and a distal end of the second bent arm extend upward from the yoke and at a desired angle with respect to the yoke.

5. The universal bracket according to claim 4 further comprising:
a distal end of the first bent arm and a distal end of the second bent arm extend downward from the yoke and at a desired angle with respect to the yoke.

6. The universal bracket according to claim 5 further comprising:
a first cylindrical clamp located at the proximal end of the first bent arm, the first cylindrical clamp having at least one fastener hole;
at least one screw that passes through the at least one fastener hole and engages with a first groove in the first boss to laterally constrain movement of the first bent arm about the first boss but allow for rotation of the first bent arm about the first boss;
a second cylindrical clamp located at the proximal end of the second bent arm, the second cylindrical clamp having at least one fastener hole; and
at least one screw that passes through the at least one fastener hole wherein the at least one screw engages with a second groove in the second boss to laterally constrain movement of the second bent arm about the second boss but allow for rotation of the second bent arm about the second boss.

7. The universal bracket according to claim 6 further comprising:
a first rod attached to a third cylindrical clamp located at a distal end of the first bent arm;
a first mudflap holder attached to the first rod;
a first mudflap attached to the first mudflap holder;
a second rod attached to a fourth cylindrical clamp located at a distal end of the second bent arm;
a second mudflap holder attached to the second rod; and
a second mudflap attached to the second mudflap holder.

8. The universal bracket according to claim 7 wherein the first and second rods each have a flared end to prevent the first and second rods from slipping through the third and fourth second cylindrical clamps during use and can only be inserted through the third and fourth second cylindrical clamps in one direction from the bracket side.

9. The universal bracket according to claim 7 further comprising:
a center line of the first cylindrical clamp and the second cylindrical clamp and a center line of the third cylindrical clamp and the fourth cylindrical clamp are offset from one another in all three dimensions.

10. A method for mounting a universal bracket to a vehicle hitch, the method comprising the steps of:
(a) positioning a yoke having a substantially u-shape on a top side of the vehicle hitch;
(b) positioning a first yoke cap having a substantially u-shape on a bottom side of the vehicle hitch forming a square opening between the yoke and the first yoke cap wherein only a four corners of the vehicle hitch are in contact with the yoke and the first yoke cap;
(c) passing a first bolt through the first yoke cap and into a first pocket of the yoke;
(d) placing a first nut within the first pocket and tightening the first nut to the first bolt;
(e) passing a second bolt through the first yoke cap and into a second pocket of the yoke; and
(f) placing a second nut within the second pocket and tightening the second nut to the second bolt.

11. The method according to claim 10 wherein step (c) further comprises the steps of:
passing the first bolt through a first hole through a proximal end of the first yoke cap;
passing the first bolt through a second hole in a first side member of the yoke, wherein the second hole extends from the first pocket through the first side member.

12. The method according to claim 11 wherein step (e) further comprises the steps of:
passing the second bolt through a third hole through a distal end of the first yoke cap; and
passing the second bolt through a fourth hole in a second side member of the yoke, wherein the fourth hole extends from the second pocket through the second side member.

13. The method according to claim 12 further comprising the steps of:
substituting a second yoke cap for the first yoke cap; and
inserting a first pair of fins that extend from a bottom member of the second yoke cap inside of the first side member and the second side member forming a substantially rectangular opening between the yoke and the second yoke cap to accommodate a rectangular vehicle hitch.

14. The method according to claim 13 further comprising the steps of:
attaching a proximal end of a first bent arm to a first boss extending from the first side member; and
attaching a proximal end of a second bent arm to a second boss extending from the second side member;
wherein a distal end of the first bent arm and a distal end of the second bent arm extend upward from the yoke and at a desired angle with respect to the yoke.

15. The method according to claim 13 further comprising the steps of:
attaching a proximal end of a first bent arm to a first boss extending from the first side member; and
attaching a proximal end of a second bent arm to a second boss extending from the second side member;
wherein the distal end of the first bent arm and the distal end of the second bent arm extend downward from the yoke and at a desired angle with respect to the yoke.

16. The method according to claim 14 further comprising the steps of:
screwing at least one screw that passes through at least one fastener hole in a first cylindrical clamp located at the proximal end of the first bent arm and engaging the at least one screw with a first groove in the first boss thereby laterally constraining movement of the first bent arm about the first boss but allowing for rotation of the first bent arm about the first boss; and
screwing at least one screw that passes through at least one fastener hole in a second cylindrical clamp located at the proximal end of the second bent arm and engaging the at least one screw with a second groove in the second boss thereby laterally constraining movement of the second bent arm about second boss but allowing for rotation of the second bent arm about second boss.

17. The method according to claim 16 further comprising the steps of:
attaching a first rod to a third cylindrical clamp located at a distal end of the first bent arm;
attaching a first mudflap holder to the first rod;
attaching a first mudflap to the first mudflap holder;
attaching a second rod to a fourth cylindrical clamp located at a distal end of the second bent arm;
attaching a second mudflap holder to the second rod; and
attaching a second mudflap to the second mudflap holder.

18. The method according to claim 17 further comprising the steps of:
inserting the first rod through the third cylindrical clamp from a bracket side until a flared end of the first rod abuts against the third cylindrical clamp; and
inserting the second rod through the fourth cylindrical clamp from a bracket side until a flared end of the second rod abuts against the fourth cylindrical clamp.

19. A universal bracket comprising:
a yoke having a substantially u-shape configured to attach to a first yoke cap having a substantially u-shape forming a substantially square opening between the yoke and the first yoke cap;
a square opening formed between the yoke and the first yoke cap; and
a vehicle hitch within the square opening where only a four corners of the vehicle hitch are in contact with the yoke and the first yoke cap.

20. The universal bracket according to claim 19 further comprising:
a second yoke cap substituted for the first yoke cap wherein the second yoke cap has a first pair of fins that extend from a bottom member that fit inside of the first side member and the second side member forming a substantially rectangular opening between the yoke and the second yoke cap to accommodate a rectangular vehicle hitch; wherein only the four corners of the vehicle hitch are in contact with the yoke and the second yoke cap.

21. The universal bracket according to claim 19 further comprising:
a first boss extending from a first side member of the yoke;
a second boss extending from a second side member of the yoke;
a first bent arm attached to the first boss at a proximal end of the first bent arm; and
a second bent arm attached to the second boss at a proximal end of the second bent arm;
wherein a distal end of the first bent arm and a distal end of the second bent arm extend upward from the yoke and at a desired angle with respect to the yoke.
